(19) United States
(12) Patent Application Publication
(10) Pub. No.: US 2006/0276073 A1
(43) Pub. Date: Dec. 7, 2006

(54) Accelerator

(76) Inventors: William Joseph McMurray, Tyler, TX (US); Beverly I. Duck, Tyler, TX (US)

Correspondence Address: John W. Adee, 13530 CR 2216, Tyler, TX, 75707, US

(21) Appl. No.: 11/398,892

(22) Filed: Apr. 7, 2006

Related U.S. Application Data
(60) Provisional application No. 60/668,804, filed on Apr. 7, 2005.

(51) Int. Cl. H01R 4/24

(52) U.S. Cl. 439/418

(57) ABSTRACT

For use with a communication devise such as a computer or fax machine, a Category cable including a CAT 5, CAT 5E, CAT6, CAT 7, and CAT 8. CAT refers to Category as defined in “United States Code of Federal Regulations” as are the registered jacks. A telephone cable is spliced to the Category cable. The end of the CAT cable and the end of the telephone cable have Registered Jacks attached thereto. The Registered Jacks are designated RJ and include RJ-11, RJ-12, RJ-25, and RJ-45. When the Category cable is connected to a computer modem or fax machine these devices are speeded up provided the Registered Jacks as connected to a phone jack

This application claims the benefit of U.S. Provisional Application Ser. No. 60/668,804, filed in the name of William J. McMurray on Apr. 7, 2005, the complete disclosure of which is incorporated herein by reference.

### FIELD OF THE INVENTION

The present invention relates to communication devices and to apparatus and methods for increasing the transfer speed from one communication device to another.

### BACKGROUND OF THE INVENTION

Communication cabling and the corresponding connections are used, for examples, to connect telephones to computer modems, telephone to telephone and telephone to fax machine. There is a desire for greater speed and clarity in communicating. This invention presents a device and method for accomplishing this task by using a combination of cable and connection devices.

Several cables and connectors are useful in this invention. Some specific ones are Category 5 (CAT 5), Category 5E (CAT 5E), Category 6(CAT 6), and Category 7 (CAT 7) have been tried in Lab. Experiments and found to perform satisfactory. Category 8 (CAT 8} or (CAT 7+) is under development and it is believed it will perform as well or better than CAT 6 or 7.

The second major component of the invention is Registered Jacks. Registered Jack11 (RJ-11) and Registered Jack 25 (RJ-25) have been used with satisfactory results. Registered Jack 45 (RJ-45) is useful in some operations. All the above cables and jacks are described in the “United States Code of Federal Regulations”. The connections are also referred to as “Modular Connections. In Europe the connections are called Western Electric or Western Plugs. Other countries may use different nomenclature. These are equivalents and are considered to be covered by this invention. The jacks and their corresponding cables were developed primarily for telephone use but now have found uses in other applications.

### SUMMARY OF THE INVENTION

The present invention provides a cabling system which is a combination of two or more different systems. In particular a CAT cable is spliced to one or more RJ connectors and cable. In the presently preferred mode a Category 6 cable is spliced to the cable of a RJ-25 Jack. The Category 6 cable is a multipair cable high performance cable (usually 4 pairs) that consists of twisted pair conductors, used mainly for data transmission. The twisting of the pairs gives the cable a certain amount of immunity from the filtration of unwanted interference. The Category 6 cable has a specified frequency range of 1-250 Mhz and an attenuation of 21.7 dB. Attenuation is the loss of signal in a cable segment due to the resistance of the wire plus other electrical factors that cause additional resistance. Category 5/5E cable has a specified frequency range of 1-100 and an attenuation of 24 dB. It is often referred to as Ethernet cable. Category 7 cables have a specified frequency range of 1-600 and an attenuation of 20.8.

The preferred Registered Jack is RJ-25. The RJ-25 is a standard modular connector using 6 connecting wires. It normally used to implement a 3-line telephone connection. RJ-11 and RJ-45 registered jacks are suitable for use by this invention. Registered Jack 45 is a telephone connector with 8 wires>It is normally slightly larger than the RJ-25 The RJ-11 is similar to RJ-25 but has less capacity.

In this invention a Category cable is spliced to a telephone cable having a Registered Jack. The wires in the Category cable are matched with the wires in the telephone cable. The wires are normally color coded to make splicing the correct wires together an easy task. In most instances a second Registered Jack is spliced to the other end of the Category cable. It would be possible to hard wire the telephone cable instead of using an RJ jack but this would ordinarily not be convenient or practical.

The cable assembly has many uses. Examples of use are, connecting between an incoming telephone line and a computer modem the computer is speeded up and the time the search the internet is accelerated by 3 to 8 times and in some instances more. For example it required less than 3 seconds to go from AOL home page to the Patent and Trademark search site. Without the invention it required over a minute. NASA.GOV required less than 6 seconds. GSA.GOV required less than 4 seconds. With the cable assembly connected between a telephone wall jack and an analog telephone the analog phone to performed like a digital phone. When connected in a telephone line to a fax machine, the fax machine performed much faster than before the cable assembly was added.

### BRIEF DESCRIPTION OF THE DRAWINGS

FIG. 1 is a Category 5E, 6 or 7 cable with wires prepared to be spliced to the wires of a Registered Jack 11, 25, or 45.

FIG. 2 illustrates the cable of this invention with one end attached to a computer and another end attached to a telephone line.

FIG. 3 illustrates the cable of this invention connected between a telephone in line and an analog telephone.

FIG. 4 shows a Category Cable with the wires prepared to be spliced to the wires connected to a RJ plug.

FIG. 5 shows an RJ plug with its wires to be spliced to the wires of FIG. 4.

FIG. 6 illustrates a receptacle for the RJ plug of FIG. 5.

FIG. 7 Illustrates a CAT 6 cable with an RJ 25 connector at each end of the cable.

FIG. 8 is the same as FIG. 7 except the cable is a Cat 5E cable.

FIG. 9 Illustrates two Cat cables with an RJ 25 at each end of the first cable and a RJ25 at one end of the second cable and a USB 2.0 at the opposite end.

FIG. 10 Illustrates a speed increaser.

### DESCRIPTION OF THE PREFERRED EMBODIMENT

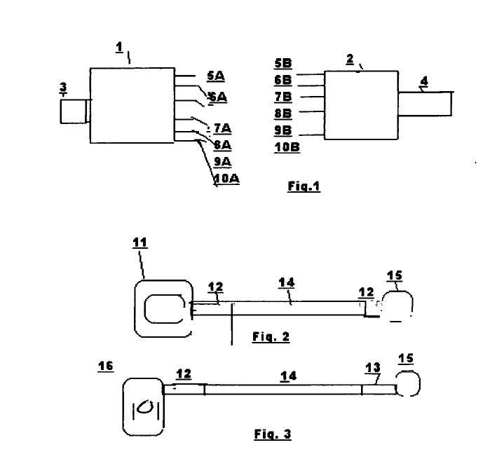

FIG. 1 is a view of a Category Cable (CAT) 3. The cable is preferable a CAT 6, however a Cat 5E or CAT 7 are also suitable. Also shown is an RJ jack cable 4 with the wires 5b, 6B, 7B, 8B, 9B, and 10B prepared to be connected to the wires 5A, 6A, 7A, 8A, 9A, and 10A. The ends of the cables 3 and 4 are enlarged to better show the ends 1 and 2. When using cable conforming to the “United States Code of Federal Regulations” as almost all commercial cables do, the wires are color coded, which makes splicing easier. In the standards the colors are blue, blue-white, orange, orange-white, green and green-white. The Category cables have six wires or six pairs of twisted wires. Some of the Category 7 cables may have 8 wires or pairs of wires. The RJ 25 cables have 6 wires as do many of the RJ 11. Some RJ 11 connectors and cables have only 4 wires. These should normally be avoided as they give inferior results. The RJ 45 connector and cable have 8 wires. In this case the last two wires are not used.

FIG. 2 shows the cable assembly having a Category cable 14 which is preferably a Category 6 cable spliced to Registered jacks 12 and 13 cables. The Jacks are preferably RJ 25, but may be RJ11 which have six wires. One RJ jack 12 is connected to the modem of a computer 11. The other RJ jack 13 is connected to a telephone line through a plate such as a wall plate. The computer operates faster than when the telephone line is connected straight to the modem, both in regular mode and when connected to the internet.

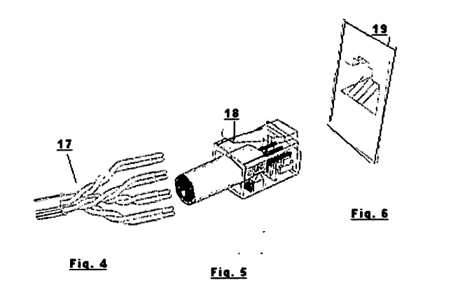

FIG. 3 shows the cable as described in FIG. 2 except it is connected to an analog telephone 16 instead of the computer 11. The analog phone 16 takes on the characteristic of a digital phone.

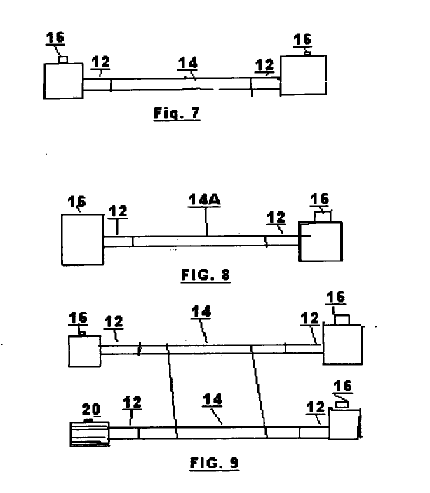

FIG. 4, FIG. 5 and FIG. 6 illustrate a Category cable 17 positioned to be connected to the wires of an RJ jack 18. The RJ jack is positioned to be inserted into telephone wall jack 19.

FIG. 7 illustrates a CAT 6 cable 14 having A RJ 25 connector 16 with its corresponding wires 12 at one end and a second RJ 25 connector 16 with wires 13 at the other end.

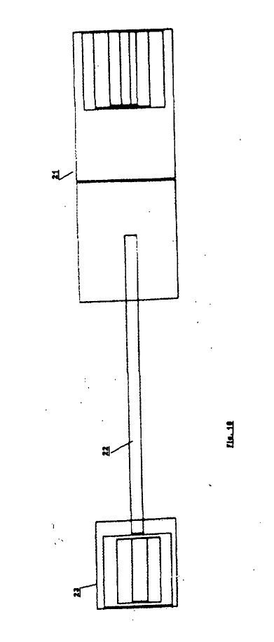

FIG. 8 is the same as FIG. 7 except the cable 14 A is a Cat 5E cable.

FIG. 9 illustrates the cable of FIG. 7 combined with a cable in which one of the RJ 25's is replaced with a USB 2.0. When both cables are used together the first is connected to the modem of the computer while the other cable is connected to a USB port. In some computers the computer runs faster than with the cable while on other computers it will not work as well. It requires experimentations to determine whether the combination is beneficial.

FIG. 10 discloses a further addition to the invention which usually increase the operating speed of a computer. The devise has a 5E enhanced cable 22 connected to a Cat 5E keystone jack 21 at one end and an RJ 12 modular phone plug 23 at the other end. In use the jack 21 is connected to one end of a Cat cable such as a 5E verified cable enhanced. The Cat cable's other end is connected to a telephone inlet such as a RJ12 phone jack. The RJ 12 is connected to a computer modem. This arrangement increases the speed of the computer substantially. For example in one test a program which normally required over 4 hours to download was downloaded in 39 minutes.

While the invention has been described with references to specific embodiments, it will be understood by those skilled in the art that various changes may be made without departing from the true spirit and scope of the invention. In addition modifications maybe made without departing from the essential teachings of the invention.

I claim:

1. A category cable having spliced to one end of said cable a telephone cable, said telephone cable having means to connect said telephone cable to a telephone line.

2. The cable of claim 1 further including means connecting said cable to a computer.

3. The cable of claim 1 further including means connecting said cable to a fax machine,

4. The cable of claim 1 said cable being a 5E category cable and the connecting means is a RJ 12 jack

5. The subject matter of claim 2 in which the connecting means is either a RJ 11, RJ 12, RJ25 or RJ45.

6. The subject matter of claim 1 in which the Category cable is a 5, 5E, 6, 7 or 8.

7. A Category cable spliced to a telephone cable, one end of said cable having a Registered Jack for connecting to a communication device and the telephone cable having a Registered Jack capable of being connected to a telephone jack.

8. In combination a telephone jack connected to a telephone line, a category 5E cable spliced to said telephone cable, a 5E keystone jack fastened to said 5E cable, the keystone jack connectable to a computer modem whereby the speed of the computer is increased.

9. The combination of claim 8 wherein said telephone jack is a RJ 45 jack.
